(19) United States
(12) Patent Application Publication
(10) Pub. No.: US 2010/0070931 A1
(43) Pub. Date: Mar. 18, 2010

(54) METHOD AND APPARATUS FOR SELECTING AN OBJECT

(75) Inventor: Paul NICHOLS, Raleigh, NC (US)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: Sony Ericsson Mobile Communications AB, Lund (SE)

(21) Appl. No.: 12/210,582

(22) Filed: Sep. 15, 2008

(51) Int. Cl. G06F 3/033

(52) U.S. Cl. 715/863

(57) ABSTRACT

A device and method for selecting objects on a touch-sensitive display are described. The device includes a touch-sensitive display for displaying at least one object, the touch-sensitive display responsive to a user input, a selection detection section operatively coupled to the touch-input display, the selection detection section configured to detect a back-and-forth movement of the user input when the input is in contact with the touch-sensitive display and to select an object on the touch-sensitive display for further operation when the back-and-forth motion is in proximity to the object.

### TECHNICAL FIELD OF THE INVENTION

The invention relates to electronic equipment, and more particularly to selecting an object displayed on a touch-sensitive display.

### DESCRIPTION OF THE RELATED ART

In recent years, portable communication devices, such as mobile phones, personal digital assistants, mobile terminals, etc., continue to grow in popularity. As the popularity of portable communication devices continues to grow, the applications for and features of portable communication devices continue to expand. Portable communication devices are appealing to users because of their capability to serve as powerful communication, data service and entertainment tools.

The wireless industry has experienced a rapid expansion of mobile data services and enhanced functionality. In addition, the features associated with certain types of portable communication devices have become increasingly diverse. To name a few examples, many portable communication devices have text messaging capability, web browsing functionality, electronic mail capability, video playback capability, audio playback capability, image display capability and hands-free headset interfaces.

Most mobile phones include a liquid crystal display (LCD) to accommodate the information display requirements associated with today's mobile phones. In addition, touch input devices, such as touch screens or touch-sensitive displays, have become popular. These devices allow for user input by touching the screen or other touch-sensitive area with a finger or stylus.

A touch-sensitive display may be used to display one or more icons for user selection. The icons typically relate to different functionality on the mobile device, for example, the icons may relate to different programs that can be run on the device (e.g., an internet navigation program, a word processing program, a media player, etc.) or the icons may relate to user settings. The touch-sensitive display also may be used to enter characters, text, or other information into the mobile device and to send and receive messages or emails, phone calls, etc.

Icons on the touch-sensitive display are typically displayed in an array. For example, the icons may be arranged in a three-by-four grid or a four-by-four grid. To rearrange the icons on the display, the user typically must navigate through several menus to find a manual reorder option, which presents the available objects on the display in the form of one or more lists. The user must determine, usually through trial and error, the location corresponding to each item on the list. For example, the user must learn that the fourth item on the list corresponds to the icon displayed in the first column of the second row of a three-by-four array. The user must rearrange the icons on the list to correspond to the desired location of the icons in the array on the touch-sensitive display, which may be cumbersome and time consuming.

Alternatively, the icons can be rearranged by entering a special mode on the device. The user may enter or initiate the special mode by touching and maintaining contact with an icon on the touch-sensitive display for a period of time. When the special mode is activated, the icons on the touch-sensitive display change states, for example, the icons may wiggle or float to indicate that the device is in the special mode and that the icons can be rearranged on the display. The initiation of the special mode typically is slow and inefficient since the user must wait a period of time before the mode is started and the objects can be moved on the screen.

It may be similarly difficult and cumbersome to modify textual objects or characters on the display of a touch-sensitive device.

### SUMMARY

Accordingly, the present invention allows a user of a device having a touch-sensitive display to easily perform more advanced operations. For example, a user may quickly and easily select an object and rearrange the objects on the display or open a utilities menu related to the selected object without having to enter a special configuration mode and without requiring one to wait a long period of time.

According to one aspect of the invention, a display device includes a touch-sensitive display for displaying at least one object, the touch-sensitive display responsive to a user input, a selection detection section operatively coupled to the touch-input display, the selection detection section configured (i) to detect a back-and-forth movement of the user input when the input is in contact with the touch-sensitive display, and (ii) to select an object on the touch-sensitive display for further operation when the back-and-forth motion is detected in proximity to the at least one object.

According to another aspect, the selection detection section is configured to select the object when a length of the back-and-forth motion is less than about 0.5 inches.

According to another aspect, the selection detection section is configured to select the object when the back-and-forth movement is completed in less than about 300 milliseconds.

According to another aspect, the further operation includes a movement section configured to move the selected object to a user-defined position.

According to another aspect, the movement section is configured to drag the selected object to the user-defined position.

According to another aspect, the user-defined position is where the object is positioned when the drag is stopped with an end action.

According to another aspect, the touch-sensitive display includes a grid of objects and the movement section is operable to move the selected object to a position on the grid of objects.

According to another aspect, the movement section is configured to swap the position of the selected object with the position of one of the objects in the grid of objects.

According to another aspect, the movement section is configured to shift the position of the objects in the grid of objects based upon the placement of selected object.

According to another aspect, the further operation includes an object utilities menu circuit.

According to another aspect, the object utilities menu includes functionality related to cutting, pasting, copying and/or formatting the object.

According to another aspect, the selection detection section is further configured to detect the direction of the back-and-forth motion and the further operation is based at least in part on the detected direction.

According to another aspect, the further operation includes a movement section and an object utilities menu circuit, and wherein the movement section is initiated when selection detection section selects the object after detecting a left-right-left motion and the utilities menu circuitry is initiated when selection detection section selects the object after detecting a right-left-right motion.

According to another aspect, the further operation simulates functionality related to a left mouse click if the back-and-forth movement is detected to be a left-right-left movement and functionality related to a right mouse click if the back-and-forth movement is detected to be a right-left-right movement.

According to another aspect, the user input is a stylus or a portion of the user's body in contact with the touch-sensitive display.

According to another aspect of the invention, a method of selecting an object on a touch-sensitive display including at least one object and being responsive to a user input, includes detecting movement of a user input that is indicative of a user's desire to select an object, wherein the movement of the user input includes touching the display with a back-and-forth motion in proximity to an object on the display, and selecting the object for further operation based on the detection of the back-and-forth movement of the user input.

According to another aspect, the detecting further includes measuring the length of the back-and-forth motion of the user input and selecting the object if the distance is less than a predetermined length and measuring a duration of time for the back-and-forth movement and selecting the object if the time is less than a predetermined amount of time.

According to another aspect, the detecting further includes selecting the object if the predetermined length is less than about 0.5 inches and the predetermined amount of time is less than about 400 milliseconds.

According to another aspect, the further operation includes (i) moving the selected object on the touch-sensitive display, and/or (ii) opening an object utilities menu.

According to another aspect of the invention, a program stored on a machine readable medium which, when executed by a machine, provides for selecting an object on a touch-sensitive display of a device by detecting a back-and-forth movement of a user input in contact with the touch-sensitive display selecting an object for further operation when the back-and-forth movement is detected in proximity to the object on the touch-sensitive display.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

FIG. 1 is a schematic view of an exemplary electronic equipment having a touch-sensitive display.

FIG. 2 is a schematic block diagram of relevant portions of the exemplary electronic equipment of FIG. 1.

FIG. 3 illustrates the exemplary electronic equipment of FIG. 1 with an array of icons displayed on the touch-sensitive display.

FIG. 4 illustrates the exemplary electronic equipment of FIG. 1 with text objects on the touch-sensitive display.

FIG. 5 illustrates an exemplary back-and-forth movement for selecting an object on the touch-sensitive display.

FIG. 6 illustrates a number of different variations of the back-and-forth movement for selecting an object on the touch-sensitive display.

FIG. 7A illustrates movement of a selected icon on a touch-sensitive display.

FIG. 7B illustrates swapping the positions of two icons on a touch-sensitive display.

FIG. 7C illustrates shifting the positions of the icons on a touch-sensitive display.

FIG. 8A illustrates selecting a text object on a touch-sensitive display with a back-and-forth movement and moving the text object on the touch sensitive display.

FIG. 8B illustrates swapping the positions of two text objects on a touch-sensitive display.

FIG. 8C illustrates shifting the positions of text objects on a touch-sensitive display.

FIG. 9A illustrates selecting a text object on a touch-sensitive display with a back-and-forth movement.

FIG. 9B illustrates an exemplary object utilities menu that is activated as a result of the back-and-forth movement illustrated in FIG. 9A.

FIG. 10 is a flow chart representing an exemplary method of selecting an object on a touch-sensitive display.

FIG. 11 is a flow chart representing an exemplary method of selecting and moving an object on a touch-sensitive display.

FIG. 12 is a flow chart representing an exemplary method of selecting an object and opening an object utilities menu on a touch-sensitive display

### DETAILED DESCRIPTION OF EMBODIMENTS

The present invention will now be described with reference to the drawings, wherein like reference numerals are used to refer to like elements throughout.

The term “electronic equipment” includes portable radio communication equipment. The term “portable radio communication equipment,” which herein after is referred to as a “mobile radio terminal,” includes all equipment such as mobile telephones, pagers, communicators, i.e., electronic organizers, personal digital assistants (PDAs), smartphones, portable communication apparatus, portable communication device or the like.

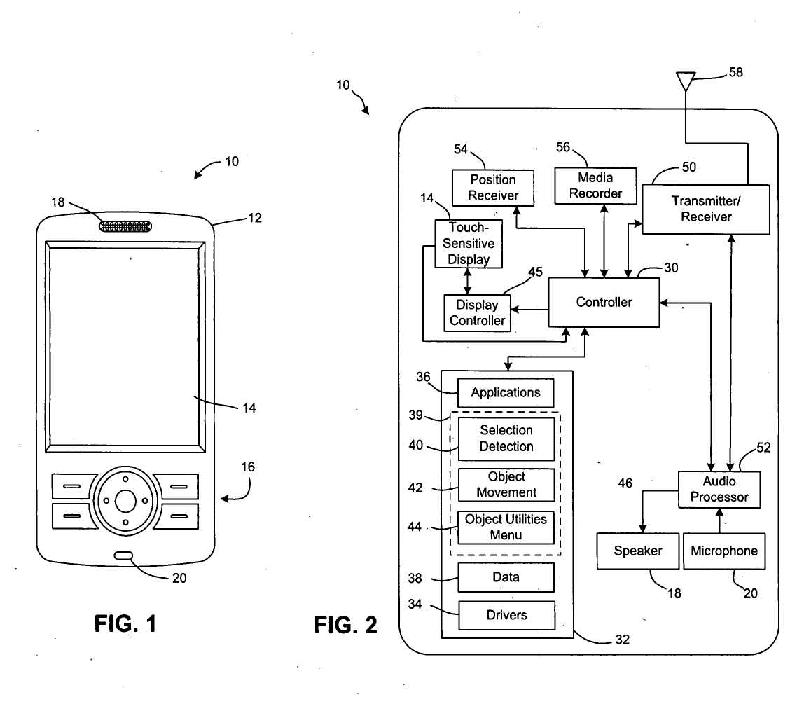

Referring initially to FIG. 1 and FIG. 2, a portable communication device 10 is shown in accordance with the present invention. In the exemplary embodiment described herein, the portable communication device is a mobile phone 10. Of course, it will be appreciated that while described primarily in the context of a mobile telephone, the invention is not intended to be limited to a mobile telephone and can be any type of electronic equipment. The description here is applicable to other portable communication devices and types of electronic equipment. The mobile phone 10 is shown as having a “block” type of housing 12, but it will be appreciated that other housing types, such as clamshell or slide-type housings may be utilized without departing from the scope of the present invention.

The mobile phone 10 illustrated in FIG. 1 is a touch-sensitive input device having a touch-sensitive display 14 (also referred to as a display, a touch screen, a touch-input device or a touch-input display). The touch-sensitive display 14 may be any conventional design that outputs information indicative of the location of a user input when the user input is in contact with the surface of the touch-sensitive display. As described in more detail below, the mobile phone is able to use the detected location of the user input on the touch-sensitive display to determine if the user is touching the display near an object on the display and to use that information to select an object for further operation based upon the detection of a back-and-forth movement of the user input in proximity to the object. The detected location of the back-and-forth movement coupled with the known location of the objects on the display allows the device to determine if the user would like to select the object for further operation, as described below.

The phone 10 may have one or more functional keys 16, e.g., a joystick or rocker key, a speaker 18 and a microphone 20. While not explicitly shown, the mobile phone also may include an alphanumeric keypad separate from any keypad embodied in the touch-sensitive display 14. The functional keys 16 (as well as any alphanumeric keypad provided by way of the touch-sensitive display or any conventional keypad), facilitate controlling operation of the mobile phone 10 by allowing for entry of alphanumeric information, such as telephone numbers, phone lists, contact information, text messages, email messages, notes and the like. The functional keys 16 typically facilitate navigation through various user menus including initiating and conducting phone calls and other communications.

The touch-sensitive display 14 displays information to a user, such as recorded digital media, e.g., recorded photos and videos, operating state, time, phone numbers, e-mails, text messages, text documents, contact information and various navigational menus, which enable the user to utilize the various features of the mobile phone 10. The touch-sensitive display 14 displays a user desktop (also referred to as a “home screen”), which may include one or more objects, such as icons for initiating one or more of the programs resident on the mobile device and/or for changing the setting of the mobile device.

The touch-sensitive display 14 is configured to sense or to detect a user input. The user input may be a user input mechanism, a user's finger or fingertip, a stylus, a pointer or another user input deice, etc. As described more fully below, the touch-sensitive display 14 is operatively coupled to a selection detection section of the device, which detects the user input and selects an object on the display for further operation, such as moving the selected object to rearrange the objects on the display or to modify the selected object, for example by accessing an object utilities menu. Artisans will appreciate that the mobile phone 10 further includes suitable circuitry and software for performing various functionality. The circuitry and software of the mobile phone is coupled with input devices, such as the alphanumeric keypad (alone or via the touch-sensitive display), the functional keys 16, and the microphone 20, as well as to the input/output devices, including the touch-sensitive display 14 and the speaker 18. It will be appreciated that the touch-sensitive display may have any suitable size, shape and positioning without departing from the scope of the present invention. Also, while the exemplary mobile phone 10 is described as having functional keys 16 and a touch-sensitive display 14, it will be appreciated that the mobile phone may include only the touch-sensitive display 14 as the primary means for receiving alphanumeric user input and/or navigation commands.

As provided in more detail below, the portable communication device includes functionality to allow a user to select an object on the display with a rapid back-and-forth movement near or in proximity to the object that the user would like to select. The user may then drag and drop the selected object to a new location and to rearrange the objects on the display in a relatively quick period of time. The user also may open an object utilities menu or initiate other functionality based upon the detected direction of the back-and-forth movement, for example, the portable communication device may initiate functionality similar to a right or left mouse click on a conventional computer and based upon the detected direction of the back-and-forth movement.

While aspects of the present invention are being described with respect to object selection via a touch-sensitive display, it will be appreciated that the object selection may be used in connection with other touch-sensitive input devices, such as a touch keypad, touch-sensitive mouse pad or another touch input device that is separate from the device display, without departing from the scope of the present invention.

FIG. 2 represents a functional block diagram of a portable communication device 10. The portable communication device 10 includes a controller 30 that controls the overall operation of the portable communication device. The controller 30 may include any commercially available or custom microprocessor or microcontroller. Memory 32 is operatively connected to the controller 30 for storing applications, control programs and data used by the portable communication device. The memory 32 is representative of the overall hierarchy of memory devices containing software and data used to implement the functionality of the portable communication device in accordance with one or more aspects described herein. The memory 32 may include, for example, RAM or other volatile solid-state memory, flash or other non-volatile solid-state memory, a magnetic storage medium such as a hard disk drive, a removable storage media, or other suitable storage means. In addition to handling voice communications, the portable communication device 10 may be configured to transmit, receive and process data, such as web data communicated to and from a web server, text messages (also known as short message service or SMS), electronic mail messages, multimedia messages (also known as MMS), image files, video files, audio files, ring tones, streaming audio, streaming video, data feeds (e.g., podcasts) and so forth.

In the illustrated embodiment, memory 32 stores drivers 34 (e.g., I/O device drivers), applications 36 and data 38, such as the coordinate and location data related to the objects on the display and the location or coordinates of the user input when the user input is in contact with the display. The data 38 may be used to determine if the movements of the user input are in proximity to an object on the display. The memory 32 also includes an object selection section 39, which includes functionality related to a selection detection section 40, an object movement section 42, an object utilities menu 44. The I/O device drivers include software routines that are accessed through the controller 30 (or by an operating system (not shown) stored in memory 32) by the applications and the object selection section 39 to communicate with the touch-sensitive display 14 and the navigation keys 16 as well as other input/output ports. The touch-sensitive display 14 is operatively coupled to and controlled by a display controller 45 (e.g., a suitable microcontroller or microprocessor) and configured to facilitate touch input functionality (detection of user touch or user input on the touch-sensitive display and recognition of desired user input based on the touch of the display). The touch-sensitive display 14 also is operatively coupled to the controller 30 and may, for example, relay detected position and coordinate location to the controller to track the position of the user input when the user input is in contact with the touch-sensitive display 14.

The applications 36 and object selection section 39 comprise functionality, programs, circuitry, commands, or algorithms, etc., that implement various features of the portable communication device 10, such as voice calls, e-mail, Internet access, text entry and editing, word processing, multimedia messaging, contact manager and the like. As is described more fully below, the selection detection section 40, the object movement section 42 and the object utilities menu 44 comprise a program(s), logic routine(s), code or circuitry to select object(s) displayed on the touch-sensitive display and to perform further operations on the selected objects, such as moving the object on the touch-sensitive display, opening an object utilities menu, etc.

With continued reference to FIG. 2, the controller 30 interfaces with the aforementioned touch-sensitive display 14 (and any other user interface device(s)), a transmitter/receiver 50 (often referred to as a transceiver), audio processing circuitry, such as an audio processor 52, and a position determination element or position receiver 54, such as a global positioning system (GPS) receiver. The portable communication device 10 may include a media recorder 56 (e.g., a still camera, a video camera, an audio recorder or the like) that captures digital pictures, audio and/or video. Image, audio and/or video files corresponding to the pictures, songs and/or video may be stored in memory 32.

An antenna 58 is coupled to the transmitter/receiver 50 such that the transmitter/receiver 50 transmits and receives signals via antenna 58, as is conventional. The portable communication device includes an audio processor 52 for processing the audio signals transmitted by and received from the transmitter/receiver. Coupled to the audio processor 52 are the speaker 18 and microphone 20, which enable a user to listen and speak via the portable communication device. Audio data may be passed to the audio processor 52 for playback to the user. The audio data may include, for example, audio data from an audio file stored in the memory 32 and retrieved by the controller 30. The audio processor 52 may include any appropriate buffers, decoders, amplifiers and the like.

The portable communication device 10 also may include one or more local wireless interfaces, such as an infrared transceiver and/or an RF adapter, e.g., a Bluetooth adapter, WLAN adapter, Ultra-Wideband (UWB) adapter and the like, for establishing communication with an accessory, a hands free adapter, e.g., a headset that may audibly output sound corresponding to audio data transferred from the portable communication device 10 to the adapter, another mobile radio terminal, a computer, or any other electronic device. Also, the wireless interface may be representative of an interface suitable for communication within a cellular network or other wireless wide-area network (WWAN).

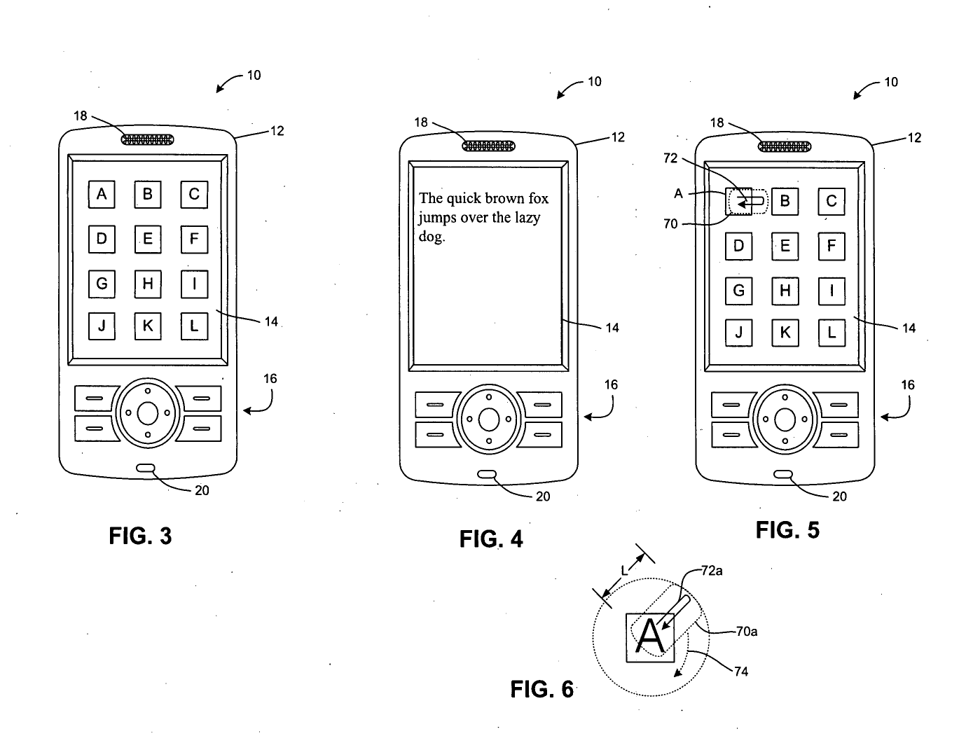

Referring to FIGS. 3 and 4, the portable communication device 10 is shown with a number of objects displayed on the touch-sensitive display 14. In FIG. 3, the objects are icons A-L, however, it will be appreciated that the objects may be other items as well, such as, for example, thumbnails, pictures, media files, text files, textual information, etc. The icons A-L may correspond to different functions or programs on the portable communication device. For example, the icons A-L may link to and initiate an internet browser, a text editor, one or more games, a media player, the device settings, or other programs and functionality as will be appreciated by one of skill in the art.

The icons A-L may be arranged in an array or grid on the touch-sensitive display 14, for example, a three-by-four array, as shown in FIG. 3. The icons A-L may be snapped to the grid to form several columns and rows of icons. It will be appreciated that while illustrated as a three-by-four array, the icons may be arranged in any manner, for example, the icons may be arranged to form a four-by-three array, two-by-three array, two-by-four array, etc. The touch-sensitive display may include any number of icons and may include more icons or fewer icons than those illustrated in FIG. 3. For example, the display may include eleven icons (e.g., A-K), more icons (e.g., thirteen or more icons), or a single icon (e.g., icon A), etc. Each icon can be activated or highlighted by tapping the touch-sensitive display with the user input on top of the icon representative of the program or function that the user would like to select. The user may start the program or function by tapping the touch-sensitive display a second time or by using functional keys 16, as will be appreciated. As described in more detail below, the objects displayed on the touch-sensitive display 14 may be selected for further operation by a back-and-forth movement near or in proximity to the icon that the user would like to select. Once selected, the user may move the icon to a new location, open an object utilities menu, or perform another operation.

As shown in FIG. 4, the objects on the touch-sensitive display 14 may be characters or text items. For example, the objects may be words typed into an e-mail message, a word processing application, a notepad application, or a text editor, etc. As will be appreciated, the text may be entered via a touch-activated keyboard, which may appear on the touch-sensitive display in accordance with the functionality of the application that is being run on the device. A separate keyboard also may be connected to the device and may be used to enter text, as may be desired. As shown in FIG. 4, the text characters appear on the touch-sensitive display 14 as they are entered by the user.

The selection detection section 40, object movement section 42 and the object utilities menu 44 are described below with respect to objects on the touch-sensitive display such as icons or text entries. It should be appreciated that the following description is equally applicable to the arrangement and rearrangement of files, file lists, play lists, audio/visual files (e.g., media files, pictures, music, video files, etc.), thumbnails, etc.

Referring to FIG. 5, the back-and-forth movement of the user input is shown by dashed lines 70, which represents the area of contact between the user input and the touch-sensitive display 14. The location information for the objects displayed on the touch-sensitive display is stored in the memory of the mobile device. The location of the touch is sensed by the touch-sensitive display and used to determine if the touch is in proximity to or near the known location of the objects on the touch-sensitive display. If the back-and-forth movement is in proximity to an object on the display, the object is selected for further operation.

For example, as shown in FIG. 5, the location of the back-and-forth movement 72 is near icon A. The object selection section 39 compares the location or coordinates of the detected back-and-forth movement with the coordinated or known location of the icons A-L displayed in the touch-sensitive display. The selection detection section 40 determines if the back-and-forth movement is in proximity to one of the icons on the screen and, if the selection detection section 40 detects that the back-and-forth movement 72 is in proximity to an object on the touch-sensitive display 14, the object is selected for further operation. In the example of FIG. 5, the selection detection section determines that the back-and-forth movement 72 is in proximity to icon A, and icon A is selected for further operation.

Continuing to refer to FIG. 5, the selection detection section 40 is described as it may be used to select an icon on the touch-sensitive display 14 (e.g., the icons that appear on the desktop, home screen or home page of the device). The selection detection section 40 is operatively connected to the touch-sensitive display 14 and configured to detect the user input. The selection detection section 40 is configured to sense or detect user contact with the touch-sensitive display 14 and the back-and-forth movement of the user input that is indicative of the user's desire to select an object for further operation.

The selection detection section 40 determines if the back-and-forth movement 72 is in proximity to one of the icons A-L on the touch-sensitive display 14. If the selection detection circuit 28 detects that the back-and-forth movement 72 is in proximity to an icon, then the icon is selected for further operation.

As shown in the embodiment of FIG. 5, the back-and-forth movement 72 is in a horizontal or left/right direction. The selection detection section 40 detects the contact 70 of the user input with the touch-sensitive display 14 and the back-and-forth movement 72. If the selection detection section 40 determines that the back-and-forth movement 72 is in proximity to an icon on the display, that icon is selected for further operation. As shown in FIG. 5, the selection detection section 40 detects the back-and-forth movement 72 is in proximity to icon A, therefore, icon A is selected for further operation. Similarly, if the selection detection section 40 detected a back-and-forth movement in proximity to icon B, then icon B would be selected for further operation, etc. If the back-and-forth movement is not in proximity to any of the icons, then mobile device 10 continues to operate in a conventional manner.

An icon also may be preselected or highlighted by the user by tapping the user input on the touch-sensitive display 14. For example, if the user input is the user's finger, the user may tap the touch-sensitive display on top of the icon to highlight the icon. The user may then make a back-and-forth movement with the user input near the highlighted icon to select the icon for further operation, as described in more detail below.

As will be appreciated, the user input may be a mechanism, such as a stylus, pointer, or other mechanism that can be used to touch the touch-sensitive display 14. The user input also may be a user body part, such as a user's finger tip, finger nail, or another portion of the user's body.

Variations of the contact with the touch-sensitive display 14 and the back-and-forth movement are shown in FIG. 6. Instead of a contact 70 and left/right back-and-forth movement 72 as shown in FIG. 5, FIG. 6 illustrates that the contact 70a and the back-and-forth movement 72a may be in any direction. For example, the back-and-forth movement may be in a direction indicated by the arrows 72a. The back-and-forth movement 72a may be in the vertical direction, the horizontal direction, a 45-degree angle, or another direction, as indicated generally by arrow 74.

The selection detection section 40 may be configured to sense a number of parameters related to the back-and-forth movement to determine the user's intent to select the object.

One of the parameters that may be used by the selection detection section 40 to determine if the object should be selected is the length of the back-and-forth movement of the user input on the touch-sensitive display. Continuing to refer to FIG. 6, the length of the back-and-forth movement is the distance L that the user input travels on the touch-sensitive display 14. The object may be selected if the length L is less than a specified length. For example, in one embodiment, the selection detection section 40 is configured to select the object if the length L is less than about 0.5 inches.

The system may be configured such that an object may be selected if the length L is less than a specified length, greater than a specified length, or within a specified range of specified lengths. For example, the selection detection section 40 may be configured to select the object only if the length L is within specified range. In one embodiment, the object is selected if the length L is between about 0.25-0.5 inches. In such an embodiment, the object will not be selected if the length L is not within the predetermined range, e.g., the object will not be selected if the length L is greater than about 0.5 inches or less than about 0.25 inches. It will be appreciated that these lengths are exemplary in nature and that the selection detection section 40 may be customized to select the object based upon a user-specified length or another length, and the specified lengths may be greater or less than the exemplary lengths provided above.

Another parameter that may be used by the selection detection section 40 to determine if the user intends to select the object is the amount time (also referred to as the duration) that it takes for the user to complete the back-and-forth movement. In one embodiment the object is selected if the duration of the back-and-forth movement is less than a predetermined length of time or if the length of time. In one embodiment, the object is selected if the back-and-forth movement is completed in less than about 200-300 milliseconds.

To avoid the accidental or unintended selection of an object, the selection detection section 40 may be configured to select the object only if the duration of the back-and-forth movement is within specified range, for example. For example, the object may be selected if the duration of the back-and-forth movement is between about 100-300 milliseconds. In such an embodiment, the object will not be selected if the duration of the back-and-forth movement is less than about 100 milliseconds or greater than about 300 milliseconds. It will be appreciated that these durations are exemplary in nature and that the selection detection section may be customized to select the object based upon a user-specified duration or another length of time that may be greater or less than those described above.

The selection detection section 40 also may base selection of an object on a combination of parameters, for example, the length of the back-and-forth movement, the amount of time to complete the back-and-forth movement, the proximity of the back-and-forth movement relative to an object on the display and/or other factor(s). For example, the object may only be selected if the length of the back-and-forth movement is less than a predetermined distance and if the duration of the back-and-forth movement is less than a predetermined amount of time, e.g., the object may be selected if the length of the back-and-forth movement is less than about 0.5 inches in each direction and if the duration of the back-and-forth movement is less than about 300-400 milliseconds.

It will be appreciated that the selection detection section 40 and the criteria or parameters used to select the object may be customized by the user. For example, the user may customize the selection detection section 40 to select an object if the length of the back-and-forth movement is within a desired range, is less than a specified length, etc. Similarly, the user may specify the duration of the back-and-forth movement, or the proximity of the back-and-forth movement to the object, etc.

After the object is selected with the selection detection section 40, it may be moved on the display 14 with the object movement section 42. The selected object is moved with the user input, e.g., by sliding the user input on the surface of the touch-sensitive display 14 to drag the selected object from one position to another position. The user generally must maintain contact between the touch-sensitive display and the user input to move the selected object.

The object movement section 42 is configured to move the selected object according to the location of the user input, e.g., the movement section 42 moves the object in a manner than mirrors or tracks the movements of the user input. For example, if the user moves the user input to the left, then the selected object is dragged to the left or if the user input is slid towards the top of the touch-sensitive display, then the selected object is dragged to the top of the touch-sensitive display, etc.

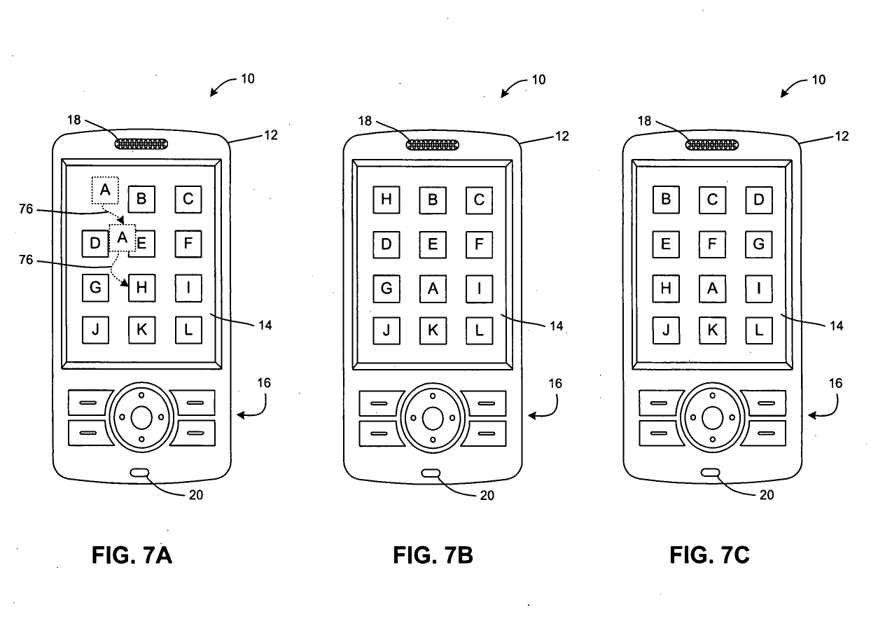

Referring to FIG. 7A, the operation of the movement section 42 is illustrated as it might be used to move icon A on the touch-sensitive display 14. After icon A is selected by the selection detection section 40, the user may drag the icon to a new position on the touch-sensitive display 14 by sliding the user input on the surface of the touch-sensitive display 14. As indicated by the arrows and dashed lines 76 in FIG. 7A, the icon can be dragged to any desired location and may be dragged along any user-defined path. A shadow of the selected object may appear near or beneath the user input when the object is being moved to allow the user to see the object and the new location of the object, e.g., as shown in FIG. 7A.

As shown in FIGS. 7B and 7C, the selected icon A may be placed relative to the other icons on the touch-sensitive display 14. Some or all of the other icons may be moved or rearranged to accommodate the new position of the selected icon A. The movement section 42 is configured to drag and drop the selected object at any desired location on the touch-sensitive display 14 by moving the object relative to the array of objects on the display.

The movement section 42 may be configured to display a preview of the new location of the selected object. For example, if the icon A is selected and slid to a position above icon H, all of the icons in the grid may be temporarily rearranged to show a preview to the user of the new layout of the icons if the icon A is placed in that position, e.g., the icons will be shifted, swapped, etc. to a temporary new position. The user can then determine if the preview of the rearranged icons is desirable and release or place the icon in the desired place. The user also may continue to move the icon to a new location to preview different arrangements, etc.

The drag may be stopped and the selected icon A may be placed or released on the display with an end action, which indicates the user's desire to release or to place the object. Upon detection of the end action the drag or ability to move the selected object is ceased and the object is placed on the display in the location of the end action. The end action may include a movement by the user input, such as a back-and-forth movement, or may be another action, such as breaking the continuity between the user input and the touch-sensitive display, e.g., by lifting the user input off of the screen. For example, the icon A also can be released or placed at the desired location by dragging the icon A to the desired location and repeating the back-and-forth movement at the new position, or if a user is using a finger to drag the icon to a new position, the icon will be dropped in the new position at the location where the user lifts the finger off of the screen or where the user repeats the back-and-forth movement. In another embodiment, the object can be placed in a new location be repeating the back-and-forth movement, and the move operation may be cancelled by removing the user input from the touch-sensitive display, in which case the selected object would be returned to its original position, e.g., its position before it was selected and moved with the user input.

When released, the object may snap to the grid or array of objects at the new location. For example, in FIGS. 7B and 7C, icon A is snapped to the grid of icons A-L in the location of icon H. The unselected icons are swapped, shifted or reordered to accommodate the new location of icon A, as described in more detail below.

The icons may be reordered in a number of different manners and the movement section may be programmed or customized to reorder the icons according to the user's preferences. Two possible options for rearranging or reordering the icons are shown in FIGS. 7B and 7C. In FIG. 7B, the position of the selected object is switched or swapped with another object on the touch-sensitive display. In FIG. 7C, the objects on the touch-sensitive display are shifted based on the new position of the selected object. It will be appreciated that other variations for reordering and/or rearranging the objects based on the new location of the selected object are possible.

In the embodiment of FIG. 7B, the positions of selected icon A and icon H, which is near the new location of icon A, are swapped. After selecting the icon A with a back-and-forth motion in proximity to the icon A, icon A is dragged to a new location of the touch-sensitive display 14 that corresponds to the position of icon H. When icon A is released with an end action, icon H is replaced with icon A, and icon H is moved to the original location of icon A, e.g., the top-left position on the touch-sensitive display (FIG. 7A). Thus, the positions of icon A and icon H are swapped.

In the embodiment of FIG. 7C, the positions of the objects are shifted based upon the new position of the selected object. As shown in FIG. 7C, icon A is snapped to the grid in the position of icon H and the icons are shifted to fill the original position of icon A and to accommodate the new position of icon A, e.g., icon B is shifted to the original position of icon A, icon C is shifted to the original position of icon B, icon D is shifted to the original position of icon C, etc. It will be appreciated that the movement section 42 may be configured to shift the icons up, down, left, right, diagonally, etc., as may be desired. It also will be appreciated that the selected object may be moved to any desired position on the touch-sensitive display, including an empty or void position on the touch-sensitive display, in which case, the icons may shift to fill the position vacated by icon A or may remain stationary.

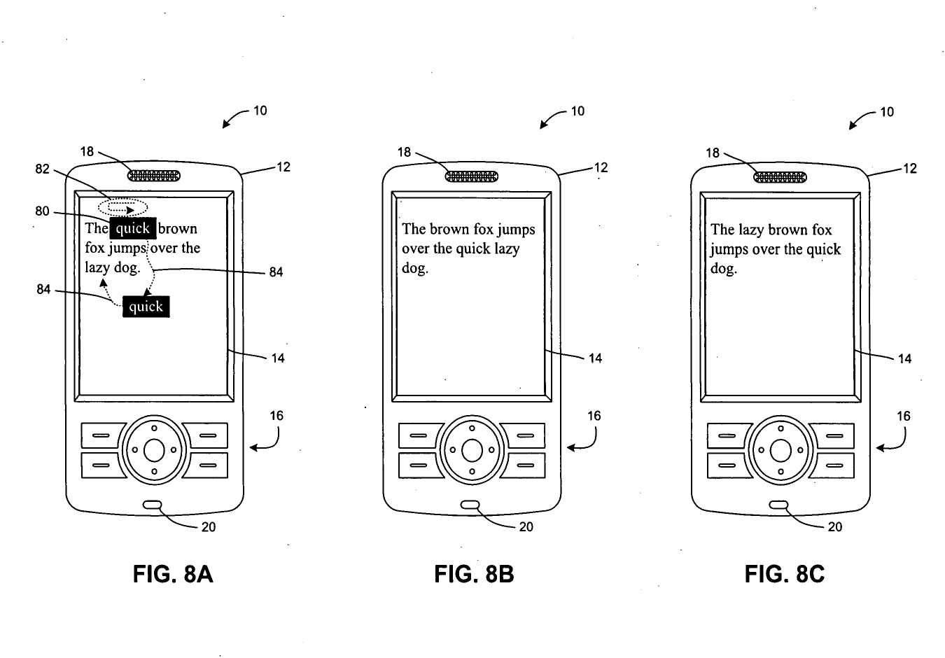

Referring now to FIGS. 8A-8C, the operation of the selection detection section 40 and movement section 42 are shown as used to select and move text objects, such as one or more characters in a text editor. As previously described with respect to FIG. 4, the mobile device may be used to enter and display text. A user may highlight text on the touch-sensitive display by tapping the screen with the user input device or mechanism. For example, the user may tap one time on the touch-sensitive display 14 to highlight a character. The user may tap two times on the touch-sensitive display 14 to select a word or set of characters. The user may tap three times on the touch-sensitive display 14 to select a line or a paragraph of text, etc.

As shown in FIG. 8A, the highlighted text 80 is a word. The user may select the highlighted text 80 for further operation with the user input by moving the user input with a back-and-forth movement in proximity to the highlighted text 80, as shown in dashed lines and arrows 82 and in a similar manner as that described above with respect to FIG. 5. The further operation on the selected text 80 may include moving the highlighted text to a new position on the touch-sensitive display 14. As described above with respect to the icons, the user input and movement section 42 may be used to move the selected text 80 to any desired location on the touch-sensitive display 14, for example, as illustrated by the dashed lines 84 in FIG. 8A.

As shown in FIG. 8B, the highlighted text can be placed such that the remaining text is shifted to a new position, for example in a manner similar to a cut-and-paste function on a word processor or a conventional text editor. The position of the highlighted text may be switched with the position of other text on the touch-sensitive display, for example, as shown in FIG. 8C.

As shown in FIG. 8B, the highlighted text 80 is the word “quick.” The highlighted text 80 is selected by the selection detection section 40, as described above. The user input is used to move the highlighted text 80 from its original position on the touch-sensitive display 14 to a new position. The highlighted text 80 on the touch-sensitive display 14 is moved with the movement section 42 by the sliding the user input on the touch-sensitive display 14. The highlighted text 80 may be placed in a new position anywhere on the touch-sensitive display 14 with an end action. As described above, the end action may be a back-and-forth movement or may be a break in the continuity between the user input and the touch-sensitive display 14, for example, by lifting the user input off of the touch-sensitive display 14. As shown in FIGS. 8A and 8B, the highlighted text 80 may be moved to the new position, e.g., to the position of the word “lazy.” The movement section 42 may be configured to shift the text on the touch-sensitive display 14, e.g., the words “lazy dog,” to accommodate or to make room for the insertion of the highlighted text 80. The movement section 42 can be configured so that the remaining text shifts right, left, up, down or diagonally, as will be appreciated.

As shown in FIG. 8C, the selected word can be swapped with another word. For example, if the word “quick” is selected and moved to the position of the word “lazy” the positions of the words may be switched, e.g., the word “quick” will take the position of the word “lazy” and the word “lazy” will be moved to the original position of the word “quick.”

It will be appreciated that a similar operation to that described with respect to FIGS. 8B and 8C may be implemented for single characters, words, one or more lines of text, paragraphs, and/or other combinations of characters, e.g., characters, words, lines of text, paragraphs, etc.

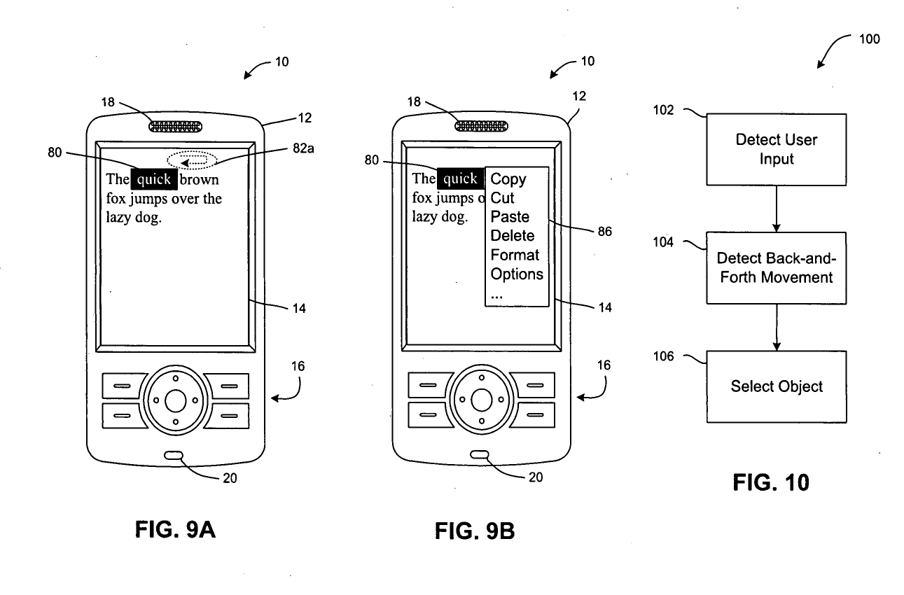

Referring to FIGS. 8A, 9A and 9B, another embodiment of the object selection section 39 is described. The object selection section 39 may be configured to detect the direction of the back-and-forth movement and to implement direction-specific operations or functionality. For example, the selection detection section 40 may detect whether the back-and-forth motion is a right-left-right movement, a left-right-left movement, and up-down-up movement, or a back-and-forth movement at a different angle or in a different direction. Based upon the detected direction of the back-and-forth movement, one or more different operations may be initiated or implemented.

As shown in FIG. 8A, the back-and-forth movement is a left-right-left movement in proximity to the object, as illustrated by the direction of the arrow 82 in FIG. 8A. The selection detection section 40 determines that the left-right-left movement 82 is in proximity to the highlighted text 80 based on the location of the detected touch and the location of the highlighted text. The left-right-left movement 82 initiates the movement section 42 to allow the user to move the selected object on the touch-sensitive display 14.

In a sense, the left-right-left movement 82 is similar to a left mouse click on a conventional computer and the left-right-left movement may initiate functionality on the touch-sensitive display that is similar to that initiated with a left mouse click on a computer. In other words, the left-right-left motion may be similar to a left click of a mouse and, after the user makes the left-right-left movement, the selected object may be dragged on the touch-sensitive display similar to the manner in which an icon or object may be dragged on a computer screen while depressing the left mouse button. The object can be dropped by repeating the left-right-left movement or by lifting the user input from the touch-sensitive display, similar to releasing the left mouse button when dragging and dropping an item on a computer screen.

As shown in FIG. 9A, the back-and-forth movement 82a is a right-left-right movement. The selection detection section 40 may be configured to detect right-left-right movement 82a and implement operations or functionality specific to the sensed direction of the movement, as shown in FIG. 9B. For example, the right-left-right movement may initiate the object utilities menu 44, which opens a menu 86 on the touch-sensitive display 14 with a plurality of user-selectable options. The object utilities menu 86 may include a number of functions and utilities related to the selected object 80. For example, the object utilities menu 86 may include options for copying, cutting, pasting, deleting, formatting and other options, etc. In FIG. 9B, the object utilities menu 86 is shown as it may relate to the selected text 80, however, it will be appreciated that the object menu utilities menu 86 may include the same or similar functionality as may be related to an icon or another selected object on the touch-sensitive display 14.

In a sense, the right-left-right movement for selecting an object on the touch-sensitive display 14 implements functionality that is similar to a right click of a mouse on a conventional computer, and a user can select an object utilities from the object utilities menu for formatting, or otherwise moving or modifying the selected object similar to the options in a menu initiated on a conventional computer with a right mouse click.

FIGS. 10-12 are flow charts representing the operation of the object selection section 39. For purposes of simplicity of explanation, the flow charts, or functional diagrams, include a series of steps or functional blocks that represent one or more aspects of the relevant operation of the portable communication device 10. It is to be understood and appreciated that aspects of the invention described herein are not limited to the order of steps or functional blocks, as some steps or functional blocks may, in accordance with aspects of the present invention occur in different orders and/or concurrently with other steps or functional blocks from that shown or described herein. Moreover, not all illustrated steps or functional blocks of aspects of relevant operation may be required to implement a methodology in accordance with an aspect of the invention. Furthermore, additional steps or functional blocks representative of aspects of relevant operation may be added without departing from the scope of the present invention. It also will be appreciated that some or all of the steps illustrated in the FIGs. may be combined into a single application or program.

As shown in FIG. 10, the method 100 of selecting an object begins with step 102. At functional block 102, the device detects contact of the user input with the touch-sensitive display. As described above, the user input may be an input mechanism or device, for example, a stylus, a finger, or another input mechanism that can be sensed by the touch-sensitive display.

The selection detection section 40 detects contact between the user input with the display and the sliding or other movement of the user input on the display. The selection detection section 40 detects when the user input is placed into contact with the touch-sensitive display 14 and taken out of contact with the touch-sensitive display 14. At functional block 104, the selection detection section 40 detects the back-and-forth movement of the user input while the user input is in contact with the touch-sensitive display 14.

At functional block 106, the object is selected in response to the user input. As described above, the selection detection section 40 is configured to select the object based upon a rapid back-and-forth movement of the user input in proximity to an object on the touch-sensitive display 14. The object may be selected based upon a number of parameters including the length of the back-and-forth movement, the duration of the back-and-forth movement, and/or the location of the back-and-forth on the display (e.g., if the back-and-forth movement is in proximity to an object), etc. For example, the object may be selected if the length of the back-and-forth movement is a specified distance, or is within a specified range.

Once selected, further operations may be performed on or with the object, as described above. For example, the further operations may include moving the selected object on the touch-sensitive display and/or opening an object utilities menu, and such functionality may be initiated based upon the detected direction of the back-and-forth movement, e.g. a right-left-right movement or a left-right-lift movement.

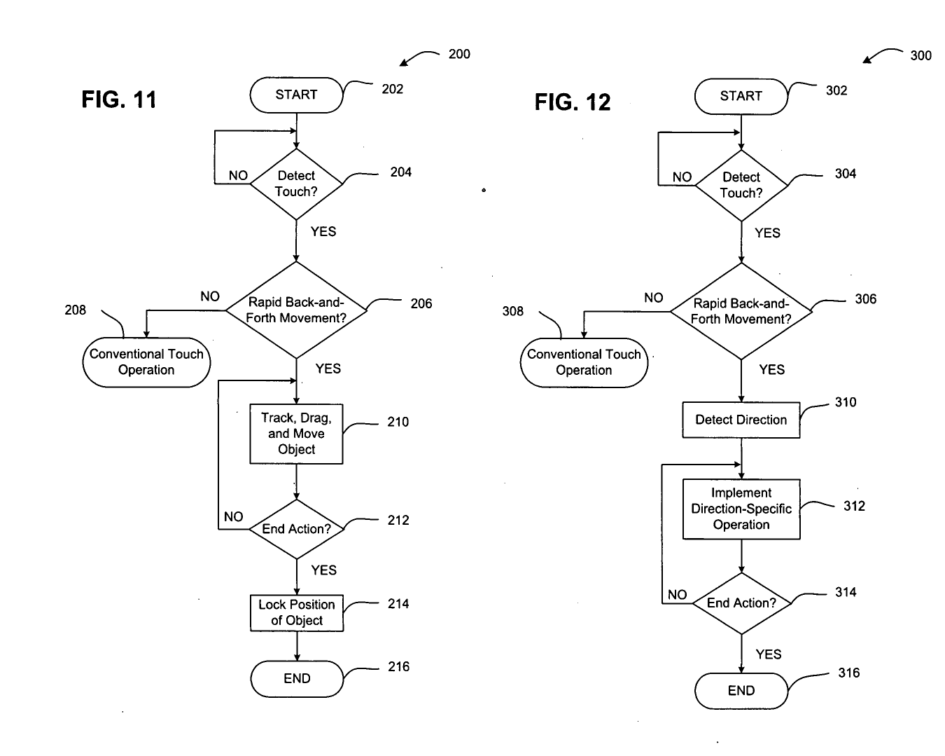

In FIG. 11, a method 200 of selecting an object and moving the object on the touch-sensitive display 14 is illustrated. The method begins at START 202. At functional block 204, is determined whether the user has touched the touch-sensitive display 14 with a user input. If the user has not touched the display 14, the program is looped back to block 204 until a touch is detected.

If the object selection section 39 detects a touch from the user input, the system proceeds to functional block 206. At block 206, the selection detection section 40 determines if the touch is a rapid back-and-forth movement in proximity to an object on the display that is indicative of the user's desire to select the object. The user may select the object with a rapid back-and-forth movement, e.g., the back-and-forth movement 72a illustrated in FIG. 6. Also, as described above, the user's desire to select the object may be determined by one or more parameters, such as the proximity of the back-and-forth movement to an object on the display, the distance of the back-and-forth movement, the duration of the back-and-forth movement, etc.

If the selection detection section 40 does not detect a rapid back-and-forth movement, or if the back-and-forth movement is not in proximity to an object on the display, the device 10 proceeds to functional block 208, in which the device continues to operate in a conventional touch mode, as shown in functional block 308.

As indicated by the loop to functional block 204, the system is configured to detect a touch and rapid back-and-forth movement at any time within the context of conventional touch operation 208, even if the initial touch of the touch-sensitive display is not a rapid back-and-forth movement. The user may use the mobile device and navigate the various icons and objects on the touch-sensitive display for several minutes or more before deciding to implement the functionality of the objection selection section 39 with a rapid back-and-forth movement. Thus, at any time during operation, the selection detection section 40 is capable of detecting a rapid back-and-forth movement. Upon detection of a rapid back-and-forth movement, the method proceeds to functional block 210.

If the selection detection section 40 detects a back-and-forth movement in proximity to an object on the display, the object is selected and for further operation the method proceeds to functional block 210, where the movement section 40 is used to move the selected object on the touch-sensitive display 14.

As described in more detail above, the movement section 40 is operable to track, drag and/or move the selected object on the touch-sensitive display 14. For example, as described with respect to FIGS. 7A-7C and 8A-8C, the position of the selected object may be switched with another object on the touch-sensitive display or the objects on the display may be shifted relative to a new position of the selected object. Also described above, the movement section 42 may track the movements of the selected object, for example, with a shadow that trails the movements of the user input, and the movement section 42 may provide a preview of the new position of the selected object and/or the remaining objects on the display as those objects would appear if the selected object was placed in a particular position.

As shown by functional block 212, the movement section 42 monitors the movement of the user input on the touch-sensitive display 14 for an end action. The end action is generally indicative of the user's desire to place the selected object at a position on the touch-sensitive display 14. Until the end action is sensed, the user may continue to move the object on the touch-sensitive display 14 as shown by the loop to functional block 210.

The end action may be any of a number of actions indicative of a user's desire to place the object at a given location on the touch-sensitive display. For example, the end action may be a back-and-forth motion, as described above. Alternatively, the user may break the contact between the user input and the surface of the touch-sensitive display 14, for example, by lifting the user input off of the touch-sensitive display 14 surface.

If the movement section 42 detects an end action, then the method proceeds to functional block 214 in which the selected object is dropped or placed in the location of the user input on the touch-sensitive display 14. The remaining objects on the display are shifted or swapped according to the new location of the selected object, as described above, and the method ends at END 216.

Referring now to FIG. 12, another method 300 of operation of the object selection section 39 is illustrated. The method 300 begins at the START 302 and detects the touch of a user input with the touch-sensitive display 14 at functional block 304, and as described above. At function block 306, the selection detection section 40 detects if the movement is rapid back-and-forth movement, e.g., a movement indicative of a user's desire to select an object on the display, also described above. If the touch from the user input is not a rapid back-and-forth movement, the device continues conventional touch operation at functional block 308.

As discussed above with respect to FIG. 11, selection detection section 40 is capable of detecting a rapid back-and-forth movement at any time during conventional operation 308, even if the initial touch is not a rapid back-and-forth movement. If at any time the selection detection section 40 detects a rapid back-and-forth movement indicative of a user's desire to select an object, the method proceeds to function block 310.

At functional block 310, the selection detection section 40 detects the direction of the back-and-forth motion. The direction of the back-and-forth motion may be indicative of the further operation that the user would like to perform on the selected object. In the embodiment described above, the selection detection section 40 determines if the back-and-forth movement is a left-right-left movement or a right-left-right movement.

At functional block 312, direction-specific operations are implemented based upon the direction detected at functional block 310. If a right-left-right back-and-forth movement is detected, then certain functionality or operations may be implemented and if a left-right-left movement is detected, then certain other functionality or operations may be implemented. For example, as described above, if a left-right-left movement is detected, then the direction-specific operation may be similar or equivalent to a left click of a mouse button on a conventional computer, e.g., a user may move, drag and drop the selected object on the screen by implementing the functionality of the movement section 42. Alternatively, if the direction of the back-and-forth movement is a right-left-right movement, then the direction-specific operation may be similar or equivalent to a right mouse click on a conventional computer and the device may implement the functionality related to the object utilities menu 44.

At functional block 314 the movement of the user input on the touch-sensitive display 14 is monitored or tracked to determine if the user has made an end action. The end action is generally indicative of the user's desire to end the device-specific operation of functional block 312. The end action may be any of a number of actions indicative of a user's desire to place the object at a given location on the touch-sensitive display. For example, the end action may be a back-and-forth motion, as described above or a break in the continuity of the contact between the user input and the touch-sensitive display 14.

If the movement section 42 detects an end action, then the method proceeds to the END 316. Otherwise, the method continues to loop through functional blocks 312 and 314 to implement the direction-specific operation.

In view of the forgoing description, including the flow charts of FIGS. 10-12, a person having ordinary skill in the art of computer programming, and specifically in applications programming or circuitry design for mobile phones, could program or otherwise configure a mobile phone to operate and carry out the functions described herein, including the selection detection section 40, the object movement section 42 and the object utilities menu 44 (and any interfacing between the applications and other applications or circuitry. Accordingly, details as to the specific programming code have been left out. Also, the selection detection functionality, the object movement functionality and the object utilities menu functionality may be carried out via the controller 30 (alone or in conjunction with other applications) in memory 32 in accordance with inventive aspects, such function also could be carried out via dedicated hardware, firmware, software or combinations thereof without departing from the scope of the present invention.

Although the invention has been shown and described with respect to certain preferred embodiments, it is understood that equivalents and modifications will occur to others skilled in the art upon the reading and understanding of the specification. The present invention includes all such equivalents and modifications, and is limited only by the scope of the following claims.

What is claimed is:

1. A display device comprising:
a touch-sensitive display for displaying at least one object, the touch-sensitive display responsive to a user input;
a selection detection section operatively coupled to the touch-input display, the selection detection section configured
(i) to detect a back-and-forth movement of the user input when the input is in contact with the touch-sensitive display; and
(ii) to select an object on the touch-sensitive display for further operation when the back-and-forth motion is detected in proximity to the at least one object.

2. The display device of 1, wherein the selection detection section is configured to select the object when a length of the back-and-forth motion is less than about 0.5 inches.

3. The display device of 1, wherein the selection detection section is configured to select the object when the back-and-forth movement is completed in less than about 300 milliseconds.

4. The display device of 1, wherein the further operation comprises a movement section configured to move the selected object to a user-defined position.

5. The display device of claim 4, wherein the movement section is configured to drag the selected object to the user-defined position.

6. The display device of claim 4, wherein the user-defined position is where the object is positioned when the drag is stopped with an end action.

7. The display device of claim 4, wherein the touch-sensitive display includes a grid of objects and the movement section is operable to move the selected object to a position on the grid of objects.

8. The display device of claim 7, wherein the movement section is configured to swap the position of the selected object with the position of one of the objects in the grid of objects.

9. The display device of claim 7, wherein the movement section is configured to shift the position of the objects in the grid of objects based upon the placement of selected object.

10. The display device of claim 1, wherein the further operation comprises an object utilities menu circuit.

11. The display device of claim 10, wherein the object utilities menu includes functionality related to cutting, pasting, copying and/or formatting the object.

12. The display device of claim 1, wherein the selection detection section is further configured to detect the direction of the back-and-forth motion and the further operation is based at least in part on the detected direction.

13. The display device of claim 12, wherein the further operation comprises a movement section and an object utilities menu circuit, and wherein the movement section is initiated when selection detection section selects the object after detecting a left-right-left motion and the utilities menu circuitry is initiated when selection detection section selects the object after detecting a right-left-right motion.

14. The display device of claim 12, wherein the further operation simulates functionality related to a left mouse click if the back-and-forth movement is detected to be a left-right-left movement and functionality related to a right mouse click if the back-and-forth movement is detected to be a right-left-right movement.

15. The display device of 1, wherein the user input is a stylus or a portion of the user's body in contact with the touch-sensitive display.

16. A method of selecting an object on a touch-sensitive display including at least one object and being responsive to a user input, the method comprising:
detecting movement of a user input that is indicative of a user's desire to select an object, wherein the movement of the user input comprises touching the display with a back-and-forth motion in proximity to an object on the display; and
selecting the object for further operation based on the detection of the back-and-forth movement of the user input.

17. The method of claim 16, the detecting further comprising measuring the length of the back-and-forth motion of the user input and selecting the object if the distance is less than a predetermined length and measuring a duration of time for the back-and-forth movement and selecting the object if the time is less than a predetermined amount of time.

18. The method of claim 17, comprising selecting the object if the predetermined length is less than about 0.5 inches and the predetermined amount of time is less than about 400 milliseconds.

19. The method of claim 16, wherein the further operation comprises:
(i) moving the selected object on the touch-sensitive display, and/or
(ii) opening an object utilities menu.

20. A program stored on a machine readable medium which, when executed by a machine, provides for selecting an object on a touch-sensitive display of a device by:
detecting a back-and-forth movement of a user input in contact with the touch-sensitive display;
selecting an object for further operation when the back-and-forth movement is detected in proximity to the object on the touch-sensitive display.
